(19) United States
(12) Patent Application Publication
(10) Pub. No.: US 2009/0235552 A1
(43) Pub. Date: Sep. 24, 2009

(54) DRYING METHOD OF FORMED CERAMIC ARTICLE

(75) Inventors: Shuichi TAKAGI, Nagoya-city (JP); Masaki Yoshida, Nagoya-city (JP); Yasuhiro Horiba, Ichinomiya-city (JP)

Correspondence Address: OLIFF & BERRIDGE, PLC, P.O. BOX 320850, ALEXANDRIA, VA, 22320-4850, US

(73) Assignee: NGK INSULATORS, LTD., Nagoya-city (JP)

(21) Appl. No.: 12/402,136

(22) Filed: Mar. 11, 2009

(30) Foreign Application Priority Data
Mar. 19, 2008 (JP) 2008-072073

(51) Int. Cl. F26B 7/00

(52) U.S. Cl. 34/437

(57) ABSTRACT

There is disclosed formed ceramic article drying means capable of evenly and uniformly drying even a large formed ceramic article containing much moisture as a drying target for a short time without causing any crack or deformation, to efficiently obtain a dry formed ceramic article having a high quality with a satisfactory yield. There is provided a drying method of a formed ceramic article including the steps of subjecting an unfired formed ceramic article formed of a ceramic material as a main material to dielectric drying and then microwave drying.

### BACKGROUND OF THE INVENTION

1. Field of the Invention

The present invention relates to a drying method of a formed ceramic article having a large moisture content.

2. Description of the Related Art

A ceramic honeycomb structure is broadly used in a catalyst carrier, various filters and the like. In recent years, the ceramic honeycomb structure attracts attention especially as a diesel particulate filter (DPF) for collecting a particulate matter (PM) discharged from a diesel engine.

Such a honeycomb structure can usually be obtained by kneading a raw material obtained by adding various additives such as water and a binder to a ceramic material to obtain a kneaded clay; preparing a formed article having a honeycomb-like shape (a formed honeycomb article) from the kneaded clay by extrusion forming; and drying and then firing this formed honeycomb article.

Heretofore, as means for drying the formed honeycomb article, there have been known a natural drying method of simply leaving the article to stand on room temperature conditions; a hot air drying method of drying the article by introduced hot air generated by a gas burner; a dielectric drying method of drying the article by high-frequency energy generated by supplying a current across electrodes provided above and below the formed honeycomb article; a microwave drying method of drying the article by a microwave and the like (e.g., see JP-A-2002-283329).

However, in the natural drying method, much time is required to obtain a sufficiently dry state. Therefore, especially when the formed honeycomb article is large, there has been a problem that a considerably long period is required to dry the article.

On the other hand, the hot air drying method has an advantage that the drying is completed for a short time as compared with the natural drying method. However, there has been a problem that cracks are easily generated, thereby incurring the lowering of quality or yield.

In the dielectric drying method, when the drying proceeds and the moisture of the formed honeycomb article decreases, impedance rises, voltage also rises, and discharge breakdown or dielectric breakdown might occur between the electrodes or in a high-frequency circuit to cause facility failure. Therefore, there is a restriction on the voltage (an output), and there has been a problem that a drying efficiency lowers especially from a medium stage to a later stage of the drying when the moisture decreases.

In the microwave drying method, when the formed honeycomb article contains much moisture and a large formed article size, the microwave does not easily penetrate to the center of the article. In consequence, there have been problems that the drying of the center delays and that it is difficult to dry the whole formed honeycomb article at a uniform speed.

### SUMMARY OF THE INVENTION

The present invention has been developed in view of the problem of such a conventional technology, and an object thereof is to provide formed ceramic article drying means capable of evenly and uniformly drying even a large formed ceramic article containing much moisture as a drying target for a short time without causing any crack or deformation, to efficiently obtain a dry formed ceramic article having a high quality with a satisfactory yield. As a result of repeated investigations, it has been found that the following means can achieve the above object, and the present invention has been completed.

That is, according to the present invention, there is provided a drying method of a formed ceramic article comprising the steps of: subjecting an unfired formed ceramic article formed of a ceramic material as a main material to dielectric drying and then microwave drying.

In the drying method of the formed ceramic article according to the present invention, it is preferable that after performing the microwave drying, hot air drying is further performed.

In the drying method of the formed ceramic article according to the present invention, it is preferable that when the moisture content of the formed ceramic article is in a range above 30 mass % or less and 10 mass % or more, the dielectric drying is performed.

In the drying method of the formed ceramic article according to the present invention, it is preferable that when the moisture content of the formed ceramic article is in a range of 30 mass % or less and 5 mass % or more, the microwave drying is performed.

Above 30 mass % or less is, for example, 40 mass % or less, 50 mass % or less or the like. That is, in the drying method of the formed ceramic article according to the present invention, for example, when the moisture content of the formed ceramic article is in a range of 40 mass % (above 30 mass %) to 15 mass % (10 mass % or more), the dielectric drying is performed. When the moisture content is in a range of 15 mass % (30 mass % or less) to 5 mass % (5 mass % or more), the microwave drying is performed. When the moisture content is in a range of 5 mass % to 0 mass %, the hot air drying may be performed. Moreover, for example, when the moisture content of the formed ceramic article is in a range of 50 mass % (above 30 mass %) to 20 mass % (10 mass % or more), the dielectric drying is performed. When the moisture content is in a range of 20 mass % (30 mass % or less) to 10 mass % (5 mass % or more), the microwave drying is performed. When the moisture content is in a range of 10 mass % to 0 mass %, the hot air drying may be performed.

The drying method of the formed ceramic article according to the present invention is preferably used in a case where the formed ceramic article is a honeycomb structure having a plurality of cells forming fluid flow paths separated from one another by partition walls. In this case, the drying method of the formed ceramic article according to the present invention is preferably used in a case where the formed ceramic article has a columnar shape, and the diameter of a circle appearing in a section of the formed ceramic article vertical to an axial direction thereof is in a range of φ150 mm or more and φ600 mm or less.

However, the drying method of the formed ceramic article according to the present invention is not means which is used only in a case where the formed ceramic article has the columnar shape. The formed ceramic article may have an arbitrary shape such as a square-rod-like shape, a plate-like shape, an annular shape or an amorphous shape. Moreover, when the formed ceramic article is the structure having the honeycomb shape, there is not any special restriction on the shape of the section crossing a cell axial direction (a flow path direction) at right angles, a cell density, partition wall thicknesses or the like.

In the drying method of the formed ceramic article according to the present invention, a time required to perform the dielectric drying, the microwave drying or the necessary hot air drying varies in accordance with the dimension, shape, surface area, moisture content or the like of the formed ceramic article. The time is usually in a range of about several ten seconds to several ten minutes. In general, when a long time is taken for each type of drying, the number of cracks to be generated decreases, but productivity deteriorates. Therefore, it cannot be considered that the long-time drying is effective.

The drying method of the formed ceramic article according to the present invention has a step of drying the unfired formed ceramic article. Therefore, it can be considered that the drying method of the formed ceramic article according to the present invention is means for manufacturing a dry formed ceramic article from a non-dry formed ceramic article.

That is, according to the present invention, there is provided a manufacturing method of a dry formed ceramic article comprising the steps of: subjecting an unfired formed ceramic article formed of a ceramic material as a main material to dielectric drying and then microwave drying to obtain the dry formed ceramic article.

In the manufacturing method of the dry formed ceramic article according to the present invention, it is preferable that when the moisture content of the formed ceramic article is in a range above 30 mass % or less and 10 mass % or more, the dielectric drying is performed.

In the drying method of the formed ceramic article according to the present invention, when the formed ceramic article has a large moisture content, first the dielectric drying is performed, because an electromagnetic wave is easily deeply penetrated and the dielectric drying is suitable for uniform drying. On the other hand, in a case where the formed ceramic article which starts to be dried has a large moisture content, the microwave drying is not performed, because the electromagnetic wave is not easily deeply penetrated, and a difference in the moisture content between the vicinity of the surface and the inside is easily made. Therefore, even the large formed ceramic article having a large moisture content can evenly be dried without causing any crack or deformation. That is, a large dry formed ceramic article having a high quality can be obtained with a high yield.

In the drying method of the formed ceramic article according to the present invention, first the dielectric drying is performed. After the moisture content of the formed ceramic article lowers, even when little moisture is contained, the output of the electromagnetic wave does not lower, and the moisture is present. In this case, the microwave drying is performed, because the moisture can be absorbed. On the other hand, when the drying proceeds and the formed ceramic article has a small moisture content, the dielectric drying is not performed, because with the rise of impedance, the voltage (the output) is restricted. Therefore, the formed ceramic article can efficiently and completely be dried for a short time.

In a preferable configuration of the drying method of the formed ceramic article according to the present invention, after performing the microwave drying, the hot air drying is further performed. Therefore, as compared with a case where the article is completely dried (until the moisture content reaches 0 mass %) by the dielectric drying or the microwave drying, a cost required for the drying can be decreased.

In a preferable configuration of the drying method of the formed ceramic article according to the present invention, when the moisture content of the formed ceramic article is in a range above 30 mass % or less and 10 mass % or more, the dielectric drying is performed. In the preferable configuration, when the moisture content of the formed ceramic article is in a range of 30 mass % or less and 5 mass % or more, the microwave drying is performed. Therefore, the above effect can securely be enjoyed.

That is, in the drying method of the formed ceramic article according to the present invention, internal heating (the dielectric drying and the microwave drying) is performed for a purpose of uniform drying (fixed-rate drying) till the completion of contraction which noticeably influences the quality (until the moisture content decreases to about 5 mass %). External heating (the hot air drying) at a low cost is performed for a purpose of lapse-rate drying after the completion of contraction which hardly influences the quality (until the moisture content decreases to about 5 mass % and the article completely dries). In addition, even when the internal heating is performed, as described above, the dielectric drying suitable for a state in which the moisture content is large is first performed, and the microwave drying suitable for a state in which the moisture content is small is performed later. Therefore, it can be considered that the drying method of the formed ceramic article according to the present invention is drying means in which the quality and efficiency are well balanced.

Moreover, when after completely drying the article, the microwave drying continues, combustion might occur. However, according to the preferable configuration of the drying method of the formed ceramic article of the present invention, since the microwave drying is performed in a moisture content range of 5 mass % or more, the above problem can be avoided.

### BRIEF DESCRIPTION OF THE DRAWINGS

FIG. 1 is a front view showing one example of a formed ceramic article (a formed honeycomb article) as a drying target of a drying method of the formed ceramic article according to the present invention;

FIG. 2 is a sectional view cut along the A-A line of FIG. 1;

FIG. 3 is a schematic diagram showing the inside of a dielectric drying device in which the formed ceramic article (the formed honeycomb article) is received;

FIG. 4 is a diagram showing the moisture distribution of the formed honeycomb article, and is a graph showing changes of a moisture content after drying/a moisture content before drying in the center and the outer periphery of the formed honeycomb article and the middle (between the center and the outer periphery) after subjecting the columnar formed honeycomb article having a moisture content of 40 mass % before dried and having a diameter of 4280 mm×an axial length of 250 mm to dielectric drying until a moisture content of 11 mass % is reached on conditions that a frequency is 40 MHz and an output density is 24 kW/8.5 kg;

FIG. 5 is a diagram showing the moisture distribution of the formed honeycomb article, and is a graph showing the changes of the moisture content after drying/the moisture content before drying in the center and the outer periphery of the formed honeycomb article and the middle (between the center and the outer periphery) after subjecting the columnar formed honeycomb article having a moisture content of 40 mass % before dried and having a diameter of φ280 mm×an axial length of 350 mm to microwave drying until a moisture content of 10.7 mass % is reached on conditions that a frequency is 2.45 GHz and an output density is 20 kW/11.6 kg;

FIG. 6 is a diagram showing properties of microwave dielectric characteristics of the formed honeycomb article made of a ceramic material as a main material, and is a graph showing a relation between a product (√∈r×tan δ) of the square root of a dielectric constant ∈r at a frequency of 2.45 GHz and a dielectric loss tan δ and the moisture content of the formed honeycomb article;

FIG. 7 is a graph showing a relation between the moisture content of the formed honeycomb article and impedance at a time when a columnar formed honeycomb article having a diameter of +103 mm×an axial length of 195 mm is subjected to the dielectric drying on conditions that a frequency is 13 MHz and an output is 1.6 kW;

FIG. 8 is a constitution diagram showing a dielectric drying device used in an example; and

FIG. 9 is a constitution diagram showing a microwave drying device used in the example.

### DESCRIPTION OF REFERENCE NUMERALS

1 FORMED HONEYCOMB ARTICLE
2 PARTITION WALL
3 CELL
4 COAT LAYER
31, 32 ELECTRODE

### DESCRIPTION OF THE PREFERRED EMBODIMENT

Hereinafter, embodiments of the present invention will be described appropriately with reference to the drawings, but the present invention is not limited to these embodiments when interpreted. The present invention can variously be changed, modified, improved or replaced based on the knowledge of any person skilled in the art without departing from the scope of the present invention. For example, the drawings show the preferable embodiments of the present invention, but the present invention is not limited by configurations or information shown in the drawings. To implement or verify the present invention, means similar or equivalent to means described in the present specification is applicable, but preferable means is as follows.

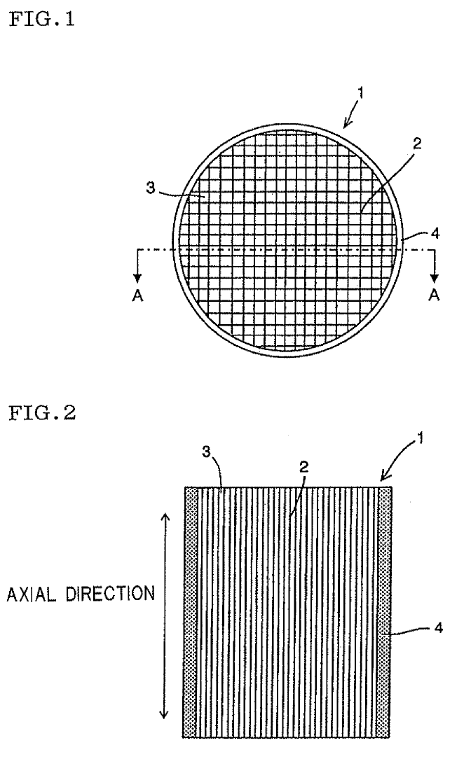

First, a formed ceramic article as a target to be dried by a drying method of the formed ceramic article according to the present invention will be described. A formed honeycomb article 1 shown in FIGS. 1 and 2 is a honeycomb-like structure having plurality of cells 3 constituting fluid flow paths separated from one another by partition walls 2, and is one example of the formed ceramic article. A coat layer 4 is arranged on the outer periphery of this formed honeycomb article 1 to surround the plurality of cells 3, and the outer shape of the article is columnar. In the formed honeycomb article 1, the shape of a section crossing the axial direction (the flow path direction) of the cells 3 at right angles is quadrangular.

The formed honeycomb article 1 is formed of a ceramic material obtained by adding various additives such as water and a binder to the ceramic material.

Examples of the ceramic material include oxide based ceramic materials such as alumina, mullite, zirconia and cordierite, and nonoxide ceramic materials such as silicon carbide, silicon nitride and aluminum nitride. Moreover, a silicon carbide/metal silicon composite material, a silicon carbide/graphite composite material or the like may be used.

Examples of the binder include polyvinyl alcohol, polyethylene glycol, starch, methyl cellulose, carboxymethyl cellulose, hydroxyethyl cellulose, hydroxypropyl methyl cellulose, polyethylene oxide, polyacrylic soda, polyacryl amide, polyvinyl butyral, ethyl cellulose, acetic cellulose, polyethylene, an ethylene-acetic vinyl copolymer, polypropylene, polystyrene, an acrylic resin, a polyamide resin, glycerin, polyethylene glycol, and dibutyl phthalate.

Moreover, the formed honeycomb article 1 is not fired (referred to as an unfired article) with a moisture content above 30 mass % or less and 10 mass % or more. The unfired article has a state in which used ceramic particles are present while keeping a formed particle shape and in which the ceramic material is not sintered.

The coat layer 4 arranged on the outer periphery of the formed honeycomb article 1 is formed by applying a layer of a coating material containing at least ceramic powder as an aggregate and water. Specific examples of a ceramic material constituting the ceramic powder contained in the coating material include materials similar to the above-mentioned examples of the ceramic material.

In addition to the ceramic powder and water, the coating material may contain a colloidal oxide (an inorganic binder) such as silica sol or alumina sol as a reinforcing material. Moreover, an organic binder such as methyl cellulose or polyvinyl alcohol may be contained as the reinforcing material. Furthermore, as the aggregate, a ceramic fiber made of amorphous mullite, silica-alumina or the like may be contained in the coating material. When these means are adopted, during the drying, the generation of cracks in the coat layer can more effectively be suppressed.

Next, a drying method of the formed ceramic article according to the present invention will be described in accordance with a case where the above formed honeycomb article 1 is dried. In the drying method of the formed ceramic article according to the present invention, after performing dielectric drying, microwave drying is performed, and further hot air drying is preferably performed. For example, the formed honeycomb article 1 may be a continuous device successively and continuously conveyed into or out of a dielectric drying device, a microwave drying device and a hot air drying device, or a batch-type device.

In the dielectric drying device (the dielectric drying method), as shown in FIG. 3, a high-frequency current of about 2 MHz or more and 100 MHz or less is applied across electrodes 31, 32 disposed above and below the formed honeycomb article 1 and facing each other, and the formed honeycomb article 1 is heated and dried from the inside owing to an internal dielectric loss. That is, in the dielectric drying device, the formed honeycomb article 1 is heated and dried in proportion to the internal electric distribution of the article.

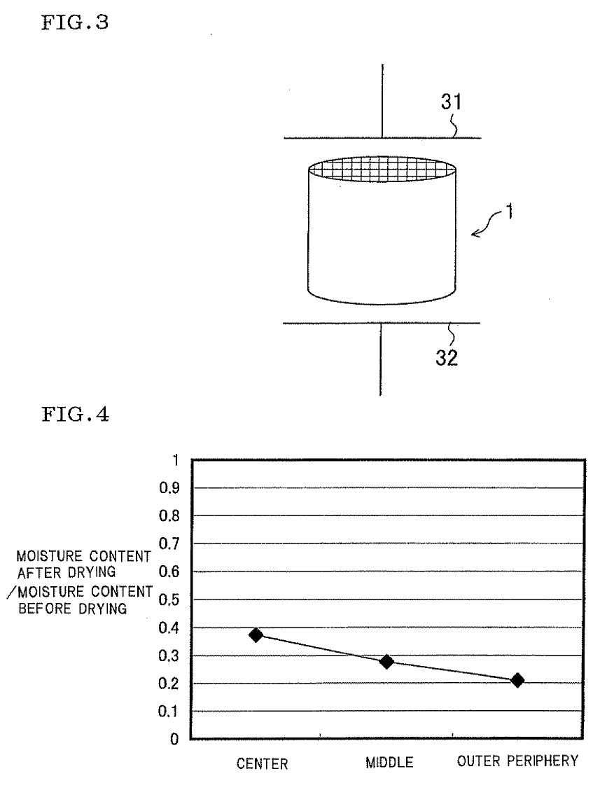

During the drying by this dielectric drying device (the dielectric drying method), as shown in FIG. 4, a difference in the moisture content is not made between the center and the outer periphery of the columnar formed honeycomb article 1. In the example of FIG. 4, a difference in the maximum moisture content ratio (=the moisture content after drying/the moisture content before drying) falls within 0.2 (20%). Therefore, an internal stress difference due to contraction is hardly generated. Even when the unfired formed honeycomb article 1 having a moisture content above 30 mass % is dried, the cracks are not easily generated by the drying.

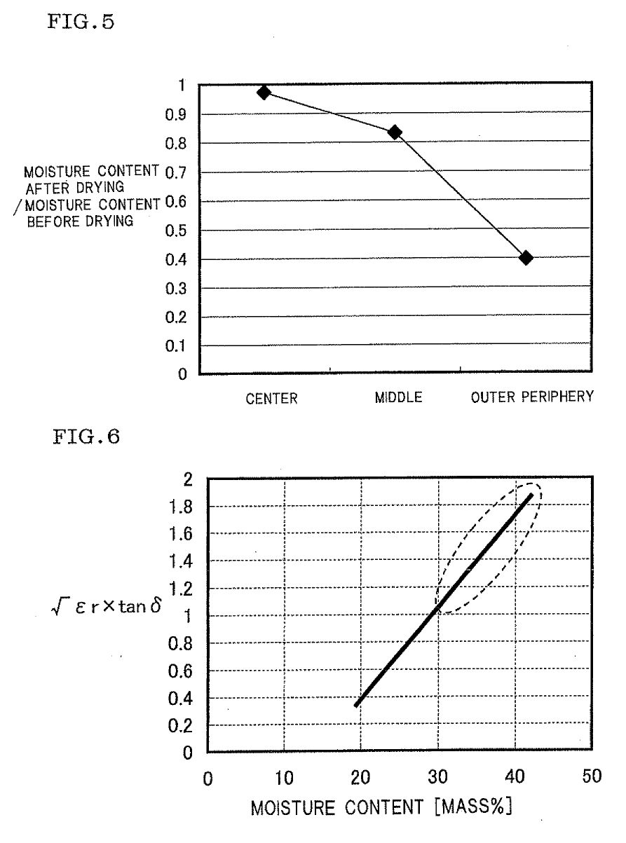

On the other hand, in the microwave drying device (the microwave drying method), as shown in FIG. 5, a large difference in the moisture content is made between the center and the outer periphery of the columnar formed honeycomb article 1. In the example of FIG. 5, a difference in the maximum moisture content ratio (=the moisture content after drying/the moisture content before drying) increases to 0.6 (60%). Therefore, when the unfired formed honeycomb article 1 having a moisture content above 30 mass % is suddenly treated by the microwave drying device, the internal stress difference due to the contraction increases, and the cracks are easily generated by the drying. In consequence, when the formed honeycomb article 1 is dried, it is essential to dry the article by the microwave drying device after lowering the moisture content by the dielectric drying device.

In the microwave drying device (the microwave drying method), the formed honeycomb article 1 is irradiated with a microwave having a wavelength of about 1 cm or more and 1 m or less (a frequency is about 300 MHz or more and 30 GHz or less) to eat and dry the formed honeycomb article 1 by electromagnetic energy of the microwave.

As described above, in the microwave drying device (the microwave drying method), a large difference in the moisture content is made between the center and the outer periphery of the formed honeycomb article 1, but this is because the microwave has a high frequency (is large). A penetration depth L_{1/2} of the microwave (the electromagnetic wave) is represented by the following equation (1). In this equation (1), f is a frequency, ∈r is a dielectric constant, and tan δ is a dielectric loss. The penetration depth L_{1/2} is inversely proportional to the frequency f. Therefore, when the frequency rises, the microwave does not reach the inside (the center) of the formed honeycomb article 1, and the inside of the article is not dried. On the other hand, the outer periphery reached by the microwave is dried, and a large difference in the moisture content is made.

$${L}_{1 / 2} = \frac{3.2 \times {10}^{7}}{f \sqrt{{ɛ}_{r}} \cdot tan δ} \qquad ( 1 )$$

Moreover, as shown in FIG. 6, as to the microwave dielectric characteristics of the formed honeycomb article 1 made of a ceramic material as a main material, there is a proportionality relation between the product of √∈r (=(∈r)^{1/2}) and tan δ and the moisture content. On the other hand, as represented by the above equation (1), the penetration depth L_{1/2} of the microwave is inversely proportional to the product of √∈r and tan δ. Therefore, when the moisture content increases, the microwave does not reach the inside (the center) of the formed honeycomb article 1, and the center is not dried. The outer periphery reached by the microwave is dried, and a large difference in the moisture content is made between the center and the outer periphery of the formed honeycomb article 1.

When a large difference in the moisture content is made between the center and the outer periphery of the formed honeycomb article 1, as described above, the internal stress difference due to the contraction increases, and the cracks are easily generated by the drying. Therefore, to dry the formed honeycomb article 1, when the moisture content is above 30 mass % (a part circularly surrounded by a broken line in FIG. 6), it is preferable that the article is not dried by the microwave drying device. In other words, when the moisture content of the formed honeycomb article 1 is 30 mass % or less, the microwave drying is preferably performed.

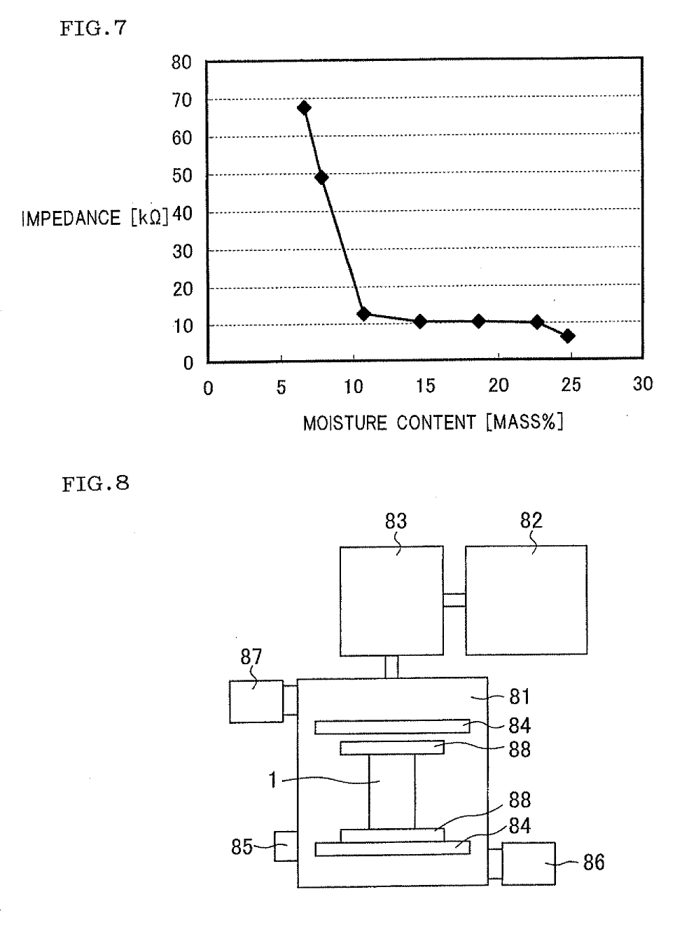

On the other hand, as shown in FIG. 7, when the moisture content of the formed honeycomb article 1 decreases, the impedance rapidly rises in the dielectric drying device (the dielectric drying method). In the dielectric drying device, when a high-frequency current is I, a voltage applied across the electrodes 31 and 32 is V and the impedance is R (see FIG. 3), an output P is obtained by the following equation (2). In the equation (2), the impedance R is inversely proportional to the output P, but the voltage V is restricted by the device. When the voltage is made constant and the impedance R increases, the output P decreases, and an efficiency lowers. In consequence, to dry the formed honeycomb article 1, when the moisture content is less than 10 mass % (a portion circularly surrounded by a broken line in FIG. 8), it is preferable that the article is not dried by the dielectric drying device. In other words, when the moisture content of the formed honeycomb article 1 is 10 mass % or more, the dielectric drying is preferably performed.

P=I·V=V²/R (2)

In the hot air drying device (the hot air drying method), the temperature of the hot air is preferably set to 100° C. or more, 130° C. or less. When the temperature is less than 100° C., much time is required to finally finish the drying of the formed honeycomb article 1. When the temperature is above 130° C., an organic binder or the like other than water included in the formed honeycomb article 1 is evaporated, and there is an increasing possibility that the formed honeycomb article 1 is deformed or that the organic binder or the like is burnt.

There is not any special restriction on the dimension of the formed honeycomb article 1. However, the effect of the drying method of the formed ceramic article is especially remarkably produced in a case where the large formed honeycomb article 1 is dried. Specifically, the method is effective when the diameter of a circle appearing in a section of the columnar formed honeycomb article 1 vertical to the axial direction thereof is +150 mm or more and +600 mm or less.

### EXAMPLE

Hereinafter, the present invention will specifically be described in accordance with examples, but the present invention is not limited to these examples.

### Example 1

[Formed Honeycomb Article] As a ceramic material, a cordierite material mixed with alumina, kaolin and talc was used, mixed with a binding material including an organic binder, a pore former and water (33 mass %) as a dispersion medium, and kneaded to obtain a kneaded clay. The resultant kneaded clay was extrusion-formed to obtain a formed honeycomb article having a diameter of 430 mm, a length (an axial length) of 600 mm, a columnar outer shape and a square sectional shape crossing the central axis of each cell at right angles. The resultant formed honeycomb article had a cell density of 300 cells/in² (in is inch and 2.54 cm in terms of SI unit), a partition wall thickness of 310 μm and a mass of 58 kg.

[Drying Method] The resultant formed honeycomb article was subjected to batch dielectric drying by use of a dielectric drying device shown in FIG. 8 with a frequency of 13 MHz and an output of 10 kW for a heating time of 30 minutes. The dielectric drying device shown in FIG. 8 includes a dielectric drying furnace 81, a high-frequency oscillator 82, a high-frequency circuit adjuster 83, electrode boards 84, a UV sensor 85, a hot air generation unit 86, an exhaust fan 87 and aluminum punching plates 88 (hole making plates).

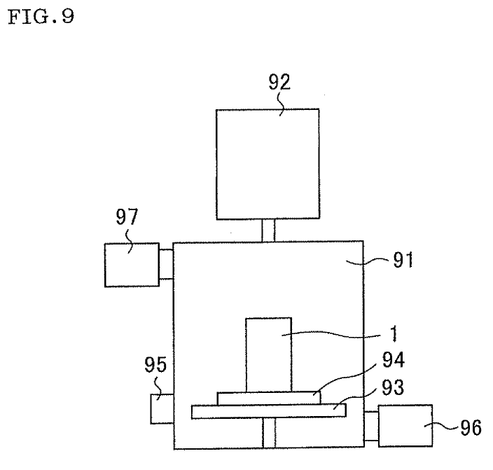

Afterward, the article was subjected to batch microwave drying by use of a microwave drying device shown in FIG. 9 with a frequency of 2.45 GHz and an output of 24 kW for a heating time of 30 minutes. The microwave drying device shown in FIG. 9 includes a microwave drying furnace 91, a microwave oscillator 92, a turntable 93, a drying pallet 94, a UV sensor 95, a hot air generation device 96 and an exhaust fan 97. The rotation speed of the turntable 93 was set to 2.7 rpm.

[Moisture Content] The moisture content of the formed honeycomb article before the dielectric drying was obtained by an initial moisture content of 33 mass %−(the mass before the dielectric drying−the mass after the dielectric drying)÷the mass before the dielectric drying×100, and the moisture content was 26%. Moreover, the moisture content of the formed honeycomb article after the microwave drying was obtained by an initial moisture content of 33 mass %−(the mass before the dielectric drying−the mass after the microwave drying)÷the mass before the dielectric drying×100, and the moisture content was 4%.

[Evaluation] The presence of cracks in the dried formed honeycomb article was visually confirmed. Moreover, discharge during the drying was detected by the UV sensors 85, 95 (R2868 manufactured by Hamamatsu Photonics K.K.). Furthermore, it was judged visually whether or not self ignition (phenomenon) by the burning of the organic binder was present during the drying. Moreover, the internal temperature of the formed honeycomb article was measured with a fiber thermometer (FX8000 manufactured by ANRITSU METER) to judge whether or not the internal temperature was the ignition temperature of the organic binder, i.e., 150° C. or more.

The results of evaluations including the presence of the cracks, the presence of the discharge and the presence of the self ignition are shown together with the specifications (the diameter, the length and the mass) of the formed honeycomb article, a drying method (a step, an output and a heating time) and a moisture content after the drying in Table 1.

### Examples 2, 3, Comparative Examples 1 to 4

One or both of the formed honeycomb article specifications and the drying method were changed. In conformity to Example 1, formed honeycomb articles were prepared and dried, moisture contents were measured, and evaluations were also performed. The results of the evaluations are shown together with the specifications of the formed honeycomb articles, drying methods and moisture contents after the drying in Table 1.

TABLE 1

| | Formed honeycomb | | Drying methods | | | | | | | | | |
|---|---|---|---|---|---|---|---|---|---|---|---|---|
| | article | | | Output [kW] | | Heating time [min.] | | Moisture content [%] | | Evaluation | | |
| | Diameter × | | | | Micro- | | Micro- | After | After | | | Self |
| | length | Mass | | Dielectric | wave | Dielectric | wave | dielectric | microwave | | | igni- |
| | [mm] | [kg] | Step | drying | drying | drying | drying | drying | drying | Crack | Discharge | tion |
| Example 1 | φ430 × 600 | 58 | Microwave | 10 | 24 | 30 | 30 | 26 | 4 | None | None | None |
| | | | drying after | | | | | | | | | |
| | | | dielectric | | | | | | | | | |
| | | | drying | | | | | | | | | |
| Example 2 | φ430 × 600 | 58 | Microwave | 10 | 24 | 60 | 12.5 | 17 | 5 | None | None | None |
| | | | drying after | | | | | | | | | |
| | | | dielectric | | | | | | | | | |
| | | | drying | | | | | | | | | |
| Example 3 | φ290 × 600 | 21 | Microwave | 10 | 24 | 18 | 7.5 | 20 | 4 | None | None | None |
| | | | drying after | | | | | | | | | |
| | | | dielectric | | | | | | | | | |
| | | | drying | | | | | | | | | |
| Comparative | φ430 × 600 | 58 | Only | — | 24 | — | 43 | — | 2 | Present | None | None |
| Example 1 | | | microwave | | | | | | | | | |
| | | | drying | | | | | | | | | |
| Comparative | φ430 × 600 | 58 | Only | 27 | — | 30 | — | 10 | — | None | Present | Present |
| Example 2 | | | dielectric | | | | | | | | | |
| | | | drying | | | | | | | | | |
| Comparative | φ430 × 600 | 58 | Only | 10 | — | 85 | — | 4 | — | None | None | Present |
| Example 3 | | | dielectric | | | | | | | | | |
| | | | drying | | | | | | | | | |
| Comparative | φ290 × 600 | 21 | Only | 10 | — | 38 | — | 7 | — | None | Present | Present |
| Example 4 | | | dielectric | | | | | | | | | |
| | | | drying | | | | | | | | | |

(Considerations) It is seen from the results shown in Table 1 that the generation of the cracks can be eliminated by using the dielectric drying in the initial stage of the drying. When the only dielectric drying is performed, to suppress the discharge, a drying output needs to be lowered. In this case, the heating time lengthens. However, when the microwave drying is performed after the dielectric drying, the heating time can be shortened. Moreover, when the only dielectric drying is performed, the ignition phenomenon due to the burning of the organic binder occurs. However, when the microwave drying is performed after the dielectric drying, the self ignition phenomenon can be eliminated.

The drying method of the formed ceramic article according to the present invention can preferably be used as drying means in a step of manufacturing a high-quality honeycomb structure broadly used in a catalyst carrier or various filters typified by a DPF.

What is claimed is:

1. A drying method of a formed ceramic article comprising the steps of: subjecting an unfired formed ceramic article formed of a ceramic material as a main material to dielectric drying and then microwave drying.

2. The drying method of the formed ceramic article according to claim 1, wherein after performing the microwave drying, hot air drying is further performed.

3. The drying method of the formed ceramic article according to claim 1, wherein when the moisture content of the formed ceramic article is in a range above 30 mass % or less and 10 mass % or more, the dielectric drying is performed.

4. The drying method of the formed ceramic article according to claim 1, wherein when the moisture content of the formed ceramic article is in a range of 30 mass % or less and 5 mass % or more, the microwave drying is performed.

5. The drying method of the formed ceramic article according to claim 1, wherein the formed ceramic article is a honeycomb structure having a plurality of cells forming fluid flow paths separated from one another by partition walls.

6. The drying method of the formed ceramic article according to claim 5, wherein the formed ceramic article has a columnar shape, and the diameter of a circle appearing in a section of the formed ceramic article vertical to an axial direction thereof is in a range of φ150 mm or more and φ600 mm or less.

7. A manufacturing method of a dry formed ceramic article comprising the steps of: subjecting an unfired formed ceramic article formed of a ceramic material as a main material to dielectric drying and then microwave drying to obtain the dry formed ceramic article.

8. The manufacturing method of the dry formed ceramic article according to claim 7, wherein when the moisture content of the formed ceramic article is in a range above 30 mass % or less and 10 mass % or more, the dielectric drying is performed.
